(19) United States
(12) Patent Application Publication
(10) Pub. No.: US 2012/0217260 A1
(43) Pub. Date: Aug. 30, 2012

(54) PACKAGING SYSTEM FOR PATIENT INTERFACE DEVICES

(75) Inventors: Richard Andrew Sofranko, Finleyville, PA (US); Lance Ranard Busch, Trafford, PA (US); Kevin Anthony Coldren, Leechburg, PA (US); Mark Alan Sellew, Belle Vernon, PA (US)

(73) Assignee: KONINKLIJKE PHILIPS ELECTRONICS N.V., EINDHOVEN (NL)

(21) Appl. No.: 13/503,454

(22) PCT Filed: Sep. 28, 2010
(86) PCT No.: PCT/IB2010/054364

§ 371 Date: Apr. 23, 2012

Related U.S. Application Data
(60) Provisional application No. 61/255,229, filed on Oct. 27, 2009.

(51) Int. Cl. B65D 83/00; B23P 17/00

(52) U.S. Cl. 221/70; 29/407.09; 221/69

(57) ABSTRACT

A packaging system for patient interface devices components that includes a macro container and a plurality of dispensing packages removeably held within the macro container. Each of the dispensing packages includes a continuous item supply including a plurality of selectively separable single item packages, wherein for each of the dispensing packages the single item packages in the continuous item supply of the dispensing package holds a patient interface device component of a type and a size that is associated with the dispensing package, and wherein each of the dispensing packages includes an opening enabling the single item packages of the dispensing package to be removed while the dispensing package is held within the macro container and markings that indicate the type and size that is associated with the dispensing package.

### CROSS-REFERENCE TO RELATED APPLICATIONS

This patent application claims the priority benefit under 35 U.S.C. §371 of international patent application no. PCT/IB2010/054364, filed Sep. 28, 2010, which claims the priority benefit under 35 U.S.C. §119(e) of U.S. Provisional Application No. 61/255,229 filed on Oct. 27, 2009, the contents of which are herein incorporated by reference.

### BACKGROUND OF THE INVENTION

1. Field of the Invention

The present invention relates to patient interface devices, and in particular to a packaging system for patient interface devices that facilitates storage, patient fitting, distribution and inventory management of such patient interface devices.

2. Description of the Related Art

Across the globe there are millions of people undergoing treatment for obstructive sleep apnea (OSA). Most of those people have been prescribed some sort of positive pressure therapy, such as continuous positive airway pressure (CPAP) therapy, for such treatment. During positive pressure therapy, a positive pressure is applied in the upper airway to splint or support the airway open, thereby preventing its collapse and the resultant airway obstruction. A typical positive airway pressure device comprises a flow generator (e.g., a blower) that delivers gas via a delivery conduit to a patient interface device. Many patient interface devices are known in the art, and typically includes a mask portion, such as, without limitation, nasal pillows with prongs which fit into the nares of the patient, nasal masks which fit over the patient's nose, nasal/oral masks that fit over the patient's mouth and nose, and full face masks which fit over the patient's entire face.

Within the group of patients being treated for OSA using positive pressure therapy, each patient has a unique face as well as a particular treatment modality for their level of OSA. The combination of unique facial structure and therapy pressure results in the need for a large variety of patient interface devices to accommodate the patient population. Each major manufacturer of patient interface devices has ever-increasing types & styles of product to address the uniqueness of the human face. In addition, each type/style of patient interface device typically comes in a number of sizes. This inherent variety poses a challenge to businesses that must supply equipment and manage inventory. Competing factors must be managed to allow businesses to operate efficiently while accommodating the facial structures of the population.

### SUMMARY OF THE INVENTION

In one embodiment, a packaging system for patient interface device components is provided that includes a macro container and a plurality of dispensing packages removeably held within the macro container. The dispensing packages include a continuous item supply including a plurality of selectively separable single item packages, wherein for each of the dispensing packages the single item packages in the continuous item supply of the dispensing package holds a patient interface device component of a type and a size that is associated with the dispensing package. Also, each of the dispensing packages includes an opening enabling the single item packages of the dispensing package to be removed while the dispensing package is held within the macro container and markings that indicate the type and size that is associated with the dispensing package. For each of the dispensing packages, the single item packages in the continuous item supply of the dispensing package may also include second markings which indicate the type and size that is associated with the dispensing package. The markings may be in human readable and/or machine readable (e.g., barcode) form.

In one particular embodiment, in each continuous item supply, each particular single item package of the continuous item supply includes a unique item count associated with the particular single item package. In another particular embodiment, in each dispensing package, the continuous item supply of the dispensing package is arranged so that the single item packages held in the dispensing package exit in and order of descending unique item count. In each dispensing package, the continuous item supply of the dispensing package may be arranged in the form of a roll. In addition, in each continuous item supply, the plurality of single item packages may be selectively separable by way of perforations.

The opening of each of the dispensing packages may be selectively provided in the dispensing package and may each comprise a perforated opening. Furthermore, one or more of the macro container, the dispensing packages and the single item packages may include patient interface device use instructions. Also, one or more of the macro container, the dispensing packages and the single item packages may include a sizing gauge.

In one particular arrangement, the dispensing packages are positioned adjacent to one another along a length of the macro container. The type that is associated with each dispensing package may be the same, while the size that is associated with each dispensing package may be different.

In another embodiment, a method of distributing patient interface device components is provided. The method includes producing a plurality of dispensing packages, wherein each of the dispensing packages includes a continuous item supply including a plurality of selectively separable single item packages, wherein for each of the dispensing packages the single item packages in the continuous item supply of the dispensing package holds a patient interface device component of a type and a size that is associated with the dispensing package. In addition, each of the dispensing packages includes an openable exit mechanism enabling the single item packages of the dispensing package to be removed from the dispensing package and markings that indicate (i) the type or type and size that is associated with the dispensing package, and (ii) an item count that is associated with the dispensing package. The method further includes accounting for the patient interface device components in the plurality of dispensing packages in an inventory system using the markings, providing on each of the dispensing packages shipping information identifying an intended recipient of the dispensing packages, and individually shipping the plurality of dispensing packages to the intended recipient.

In one particular embodiment, the markings are in machine readable form and the accounting includes reading each of the markings In another particular embodiment, in each dispensing package, the continuous item supply of the dispensing package is arranged so that the single item packages held in the dispensing package exit in and order of descending item count. Also, in each dispensing package, the continuous item supply of the dispensing package may be arranged in the form of a roll. One or more of the dispensing packages and the single item packages may include patient interface device use instructions and/or a sizing gauge.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram of a packaging system according to one particular, non-limiting embodiment of the present invention;

FIG. 2 is a schematic diagram a single-item package forming a part of the packaging system of FIGS. 1; and

FIG. 3 is a schematic diagram a dispensing package forming a part of the packaging system of FIG. 1.

### DETAILED DESCRIPTION OF THE EXEMPLARY EMBODIMENTS

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As employed, herein, the statement that two or more parts or components are “coupled” together shall mean that the parts are joined or operate together either directly or through one or more intermediate parts or components. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

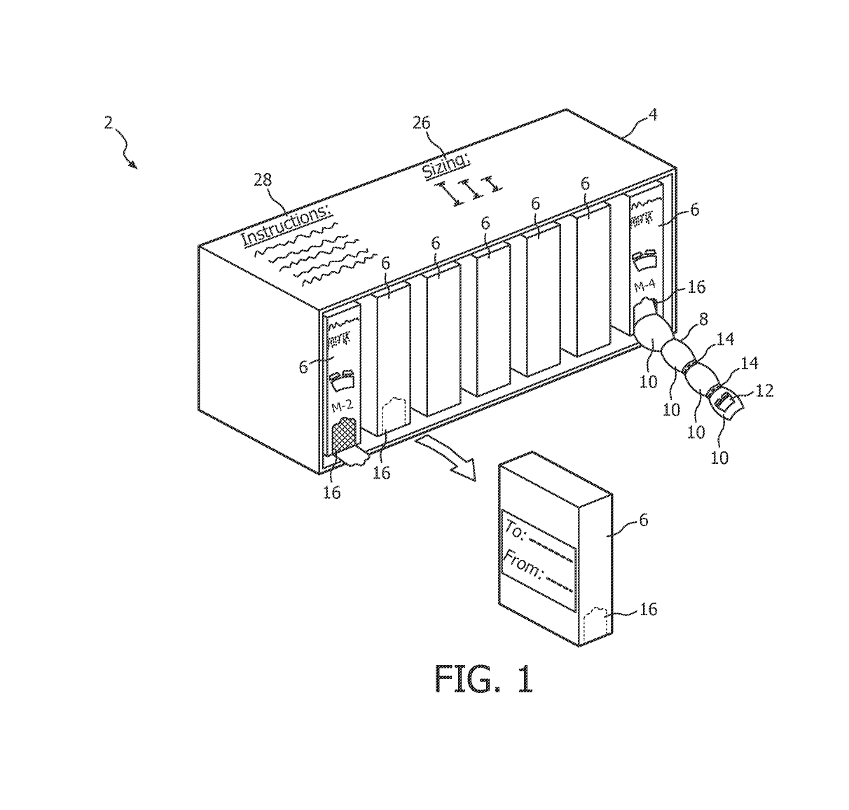

FIG. 1 is a schematic diagram of packaging system 2 according to one particular, non-limiting embodiment of the present invention. Packaging system 2 includes macro packaging container 4 which is structured to hold a number of dispensing packages 6 therein. Each dispensing package 6 is structured to hold continuous item supply 8 comprising a fixed number of single-item packages 10. The single-item packages 10 in a particular continuous item supply 8 hold patient interface device components 12 that are all of an identical type, style, and size. As used herein, the term component shall refer to any part of a patient interface device (e.g., a removable cushion, a set of removable prongs of a nasal pillow, the headgear, or any other interchangeable element typically used in a patient interface device or assembly). As used herein, the term component shall also refer to a patient interface device product in its entirety (e.g., an entire nasal mask including cushion, frame, and headgear). Thus, each dispensing package 6 holds a plurality (fixed number) of patient interface device components 12 that are all of the same particular type, style and size. For example, in the embodiment shown in FIG. 1, the patient interface device components 12 that are held in the right most dispensing package 6 are nasal pillows of the same, type, style, and size. In addition, the other dispensing packages 6 held in macro packaging container 4 can each hold nasal pillows of different types, styles and/or sizes in order to facilitate easy access thereto for fitting a patient.

In one particular embodiment, single-item packages 10 in continuous item supply 8 are readily separable from one another, for example by perforations 14 provided between adjacent single-item packages 10, so that a single single-item packages 10 can be easily obtained from continuous item supply 8. For example, continuous item supply 8 may comprise a number of single-item packages 10 each in the form of a plastic (e.g., opaque, transparent or translucent) enclosure (bag) that holds the associated patient interface device component 12, wherein such enclosures are joined at perforations 14. In the embodiment shown in FIG. 1, continuous item supply 8 is held within dispensing package 6 in the form of a roll, and is allowed to exit dispensing package 6 through perforated window opening 16 provided in dispensing package 6. While perforated window opening 16 is shown in the illustrated embodiment, other suitable exit mechanisms may also be employed.

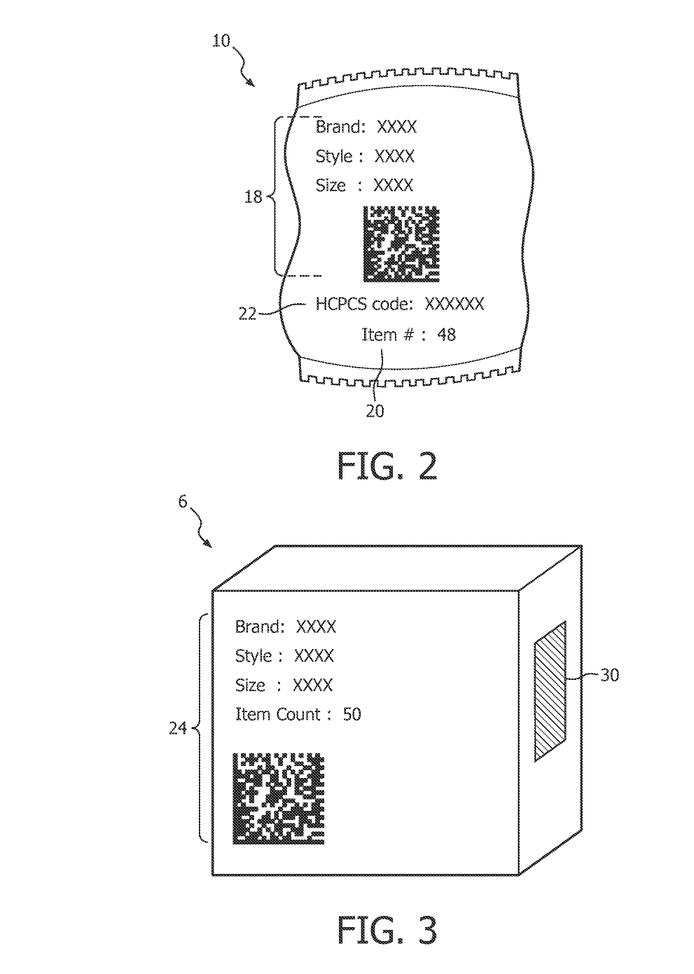

Each single-item package 10 may include markings thereon for use in inventory control and sizing. For example, as shown in exemplary single-item package 10 shown in FIG. 2, each single-item package 10 may include markings 18 that indicate the brand, type, style and/or size of the component 12 contained therein in both human readable and machine readable (e.g., 2-D bar code) forms. In addition, each individual single-item package 10 in a particular continuous item supply 8 may include marking 20 (in human readable and/or machine readable form) that indicates a unique item/part count for the individual single-item package 10 in the continuous item supply 8. For example, if continuous item supply 8 includes 50 single-item packages 10, those single-item packages 10 may be numbered 1-50 in order. In a particular embodiment, continuous item supply 8 is inserted and held within dispensing package 6 such that the individual single-item packages 10 will exit dispensing package 6 in descending item/part count order so that the unique number of the next single-item package 10 will also indicate how many single-item packages 10 remain in dispensing package 6. Also, single-item packages 10 may have HCPCS (Healthcare Common Procedure Coding System) codes 22 provided thereon for insurance billing purposes.

In addition, each dispensing package 6 may also include markings thereon for use in inventory control and sizing. For example, as shown in exemplary dispensing package 6 shown in FIG. 3, each dispensing package 6 may include markings 24 that indicate the brand, type, style and/or size of the component 12 contained therein and the number of such components 12 contained therein in both human readable and machine readable (e.g., 2-D bar code) forms.

It will appreciated that the configuration shown in FIGS. 2 and 3 that includes markings 18, 20, 22 and 24 naturally plays to the strengths of computer-controlled inventory and/or stocking methods and systems which often employ bar codes.

Furthermore, the outside of one or more of macro packaging container 4, dispensing packages 6 and single-item packages 10 may also include sizing gauge 26 (FIG. 1) for assisting in the sizing of the associated patient interface device components 12, instructions 28 for use or attachment of the associated patient interface device components 12, branding, or other useful features.

Attachment arrangements may be provided on any of macro packaging container 4, dispensing packages 6 and single-item packages 10 to control the assembly and disassembly of the packaging system 2. For instance, a hook and loop fastener system 30 (FIG. 3), such a Velcro®, can be utilized on the outside of dispensing packages 6 and the inside of macro packaging container 4 to secure dispensing packages 6 for shipment or to prevent inadvertent removal of dispensing packages 6 from macro packaging container 4. Other mechanisms such as tabs, windows, pull-throughs, adhesives, etc. are also possible for accomplishing this function.

Packaging system 2 shown in FIG. 1 is just one particular, exemplary embodiment of the present invention, and it should be understood that macro packaging container 4, dispensing packages 6 and single-item packages 10 may have shapes and/or sizes other than those shown in FIG. 1. Thus, the components of the packaging system of the present invention may have a myriad of shapes, combinations, and organization markings.

As a complete system, packaging system 2 provides a durable medical equipment supplier (DME) and/or a health care provider (HCP) an organized system of storage, distribution, and inventory management. The storage aspect is managed through the packaging of like patient interface device components 12 within each dispensing Package 6. Either as stand-alone boxes or when collected within macro packaging container 4, the inventory can be stored in a clutter-free manner that keeps a business work area organized. This is especially important during the various phases of mask fitting and trouble shooting when multiple sizes or products may be tried to obtain optimum patient satisfaction. At a lower level, the actual parts/products (the individual patient interface device components 12) are organized and individually “bagged” within single-item packages 10 contained within dispensing package 6. This level of storage within the dispensing packages 6 provides an additional level of compactness to the system. Since single-item packages 10 are separable (for instance, via perforations 14), each can be stored and distributed individually. The embodiment shown in FIG. 1 depicts a setup of seven (7) dispensing packages 6 within one macro packaging container 4. As stated elsewhere herein, this is only one possible configuration for this invention. Depending on the needs of the user/product/customer, a high level of flexibility is possible for the number of dispensing packages 6 within macro packaging container 4. Furthermore, the sizes, shapes, and count of single-item packages 10 within any particular dispensing package 6 are all variations that can be optimized for a given situation.

The distributional aspects of the invention are seen at a higher level through the dual purpose nature of dispensing package 6, which serve both as dispenser and shipping container. As noted elsewhere herein, the dispensing can be accomplished via window opening 16 or a similar suitable mechanism that can be utilized after the receiving company has the dispensing package 6 at their facility. In addition, a number of different dispensing packages 6 having continuous item supplies 8 therein can be produced by, for example, a durable medical equipment supplier (DME), and when products are ordered by a customer, each of the patient interface device components 12 in one or more dispensing packages 6 that comprise the order can be accounted for in the inventory system of the DME using the markings 24, and shipping of the order to the customer can be simply accomplished by affixing mailing labels 32 (FIG. 1) to the outside of each of the dispensing packages 6 and thereafter individually depositing the dispensing packages 6 comprising the order with a shipping carrier such as the United States Postal Service or another commercial carrier.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A packaging system (2) for patient interface device components (12), comprising:
a macro container (4); and
a plurality of dispensing packages (6) removeably held within the macro container (4), wherein each of the dispensing packages (6) includes a continuous item supply (8) including a plurality of selectively separable single item packages (10), wherein for each of the dispensing packages (6) the single item packages (10) in the continuous item supply of the dispensing package holds a patient interface device component (12) of a type and a size that is associated with the dispensing package, and wherein each of the dispensing packages includes an opening (16) enabling the single item packages of the dispensing package to be removed while the dispensing package is held within the macro container and markings (24) that indicate the type and size that is associated with the dispensing package.

2. The packaging system according to claim 1, wherein the markings (24) are in human readable and machine readable form.

3. The packaging system according to claim 1, wherein for each of the dispensing packages (6) the single item packages (10) in the continuous item supply (8) of the dispensing package includes second markings (18) which indicate the type and size that is associated with the dispensing package.

4. The packaging system according to claim 3, wherein the second markings (18) are in human readable and machine readable form.

5. The packaging system according to claim 3, wherein in each continuous item supply (8) each particular single item package (10) of the continuous item supply includes a unique item count (20) associated with the particular single item package.

6. The packaging system according to claim 1, wherein in each dispensing package the continuous item supply of the dispensing package is arranged so that the single item packages held in the dispensing package exit in and order of descending unique item count.

7. The packaging system according to claim 6, wherein in each dispensing package the continuous item supply of the dispensing package is arranged in the form of a roll.

8. The packaging system according to claim 1, wherein in each continuous item supply the plurality of single item packages are selectively separable by way of perforations (14).

9. The packaging system according to claim 1, wherein the opening (16) of each of the dispensing packages is selectively provided in the dispensing package and comprises a perforated opening.

10. The packaging system according to claim 1, wherein one or more of the macro container, the dispensing packages and the single item packages includes patient interface device use instructions (28).

11. The packaging system according to claim 1, wherein one or more of the macro container, the dispensing packages and the single item packages includes a sizing gauge (26).

12. The packaging system according to claim 1, wherein the dispensing packages are positioned adjacent to one another along a length of the macro container.

13. The packaging system according to claim 12, wherein the type that is associated with each dispensing package is the same, and the size that is associated with each dispensing package is different.

14. A method of distributing patient interface device components (12), comprising:
producing a plurality of dispensing packages (6), wherein each of the dispensing packages (6) includes a continuous item supply (8) including a plurality of selectively separable single item packages (10), wherein for each of the dispensing packages the single item packages in the continuous item supply of the dispensing package holds a patient interface device component (12) of a type and a size that is associated with the dispensing package, and wherein each of the dispensing packages includes an openable exit mechanism (16) enabling the single item packages of the dispensing package to be removed from the dispensing package and markings (24) that indicate (i) the type or type and size that is associated with the dispensing package, and (ii) an item count that is associated with the dispensing package;
accounting for the patient interface device components in the plurality of dispensing packages in an inventory system using the markings;
providing on each of the dispensing packages shipping information identifying an intended recipient of the dispensing packages; and
individually shipping the plurality of dispensing packages to the intended recipient.

15. The method according to claim 14, wherein the markings (24) are in machine readable form and the accounting includes reading each of the markings.

16. The method according to claim 14, wherein in each dispensing package the continuous item supply of the dispensing package is arranged so that the single item packages held in the dispensing package exit in and order of descending item count.

17. The method according to claim 16, wherein in each dispensing package the continuous item supply of the dispensing package is arranged in the form of a roll.

18. The method according to claim 14, wherein one or more of the dispensing packages and the single item packages includes patient interface device use instructions (28).

19. The method according to claim 14, wherein one or more of the dispensing packages and the single item packages includes a sizing gauge (26).
